(19) United States
(12) Patent Application Publication
(10) Pub. No.: US 2017/0262496 A1
(43) Pub. Date: Sep. 14, 2017

(54) METHOD FOR DATABASE INTEGRATION USING A GUI TO GENERATE SQL QUERIES

(71) Applicants: Chris Nethery, Naples, FL (US); Colby Brannan, Naples, FL (US)

(72) Inventors: Chris Nethery, Naples, FL (US); Colby Brannan, Naples, FL (US)

(21) Appl. No.: 15/064,583

(22) Filed: Mar. 8, 2016

(51) Int. Cl. G06F 17/30; G06F 3/0482; G06F 3/0484

(52) U.S. Cl. CPC G06F 17/30392; G06F 17/30398; G06F 3/04842; G06F 3/0482; G06F 17/30498; G06F 17/30339

(57) ABSTRACT

The invention relates to a novel method for using a Graphical User Interface (GUI) to generate simple SQL queries that create arbitrary and ad hoc relational database topologies. The method is simple, yet highly effective in allowing a user to create queries which are functional in producing usable data sets germane to the user's function or organization, and are not burdened by heavy reliance on a rules based regime.

### FIELD

The invention relates to a novel method for using a Graphical User Interface (GUI) to generate simple standard query language (SQL) queries that create arbitrary and ad hoc relational database topologies. The application of transact-SQL (T-SQL) generates database integration in a simplified manner eliminating heavy reliance on a rules based regime.

### BACKGROUND OF THE INVENTION

The invention most closely corresponds with USPTO Class 707/769 wherein Class 707 relates to data processing: database and file management or data structures and sub-class 769 includes database query processing.

In its simplest form, the invention relates to a novel method of database integration which uses a GUI and transactional SQL to effect a set of data rather than relying on rules based regimes or utilization of JOINS (retrieving data from two or more tables based on logical relationships between the tables). Using JOINS requires each table of data to have specific table names. Using a SELECT statement is sometimes difficult to understand because there is nothing to indicate the table that provided each column. Readability may be affected by aliases or table name discrepancy or if labeling is not present.

T-SQL is a set of programming extensions from Sybase and Microsoft that add several features to the Structured Query Language (SQL) including transaction control, exception and error handling, row processing, and declared variables. The inventive method implements patterns that simplify queries to just a few repeatable patterns.

### THE INVENTION

### Summary, Objects and Advantages

The inventive method's representative queries define the grammar for database table structures and relationships. This differs from current common practices wherein the database table structures and relationships are defined by the database grammar, e.g. the inventive method is converse to the prior art.

The method simplifies the invocation of complex queries containing “n-JOINS” and “n-SUBSELECTS”, and allows the end-user to arbitrarily define the structure of the data within a query, and how the query is to run. This method differs significantly from current common practices whereby the structure of the data itself is defined within the CREATE TABLE statement only, thereby eliminating extensive and complex queries to invoke.

Another advantage of the inventive method is that traditional naming conventions, such as those used in Microsoft Windows, do not limit the user of the inventive method when creating data sets as they are not then resultant or limited by table names. A parent directory is not required since the method defines the data within the CREATE TABLE statement and does not rely on path locators or any number of other complex queries typically required to create data sets.

One thing that most programmers can agree on is the steps, hierarchy, language restrictions, and structure of database creation and use is often excessively complex. The inventive method allows a user to simply create a useable data query without protracted code, and wherein the data set results in an immediately utilizable query to locate and employ data which benefits the operation of its entity, function, or organization. The inventive method is precise, free of excess hierarchy, and produces value-added data for an end user.

### BRIEF DESCRIPTION OF THE DRAWINGS

The invention is described in further detail by reference to one drawing which is simple and yet sufficient in detail to describe the invention in which:

FIG. 1 is a schema diagram which simply but clearly illustrates the steps in the inventive method of utilizing a GUI and T-SQL to create simple queries.

### DETAILED DESCRIPTION, INCLUDING BEST MODES OF CARRYING OUT THE INVENTION

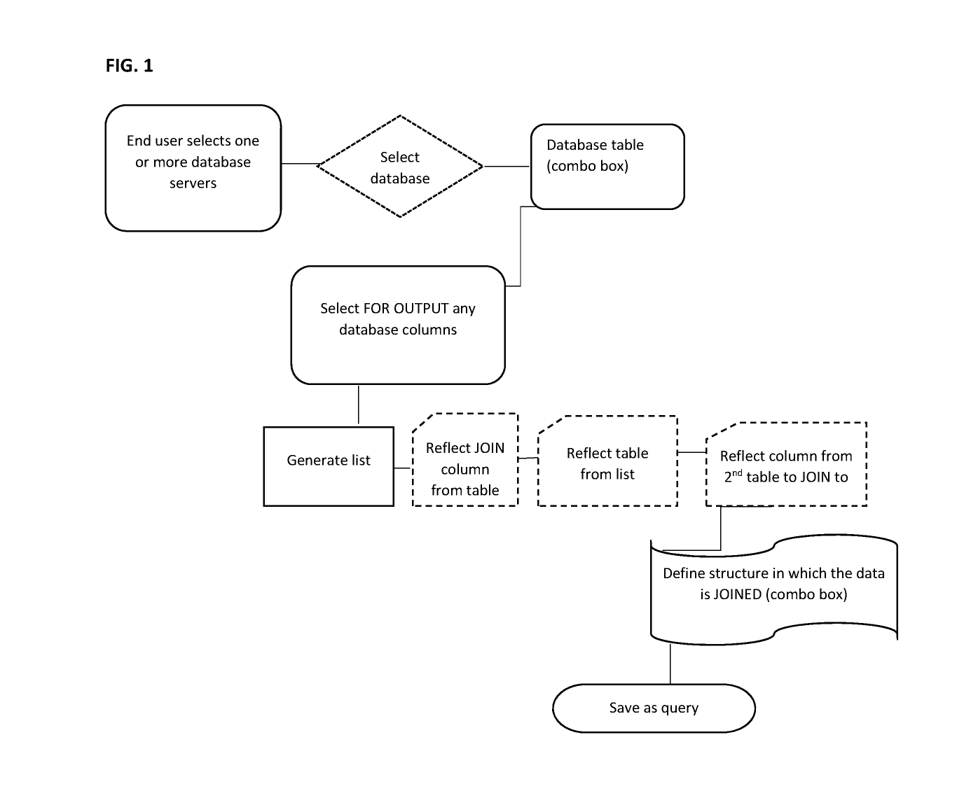

FIG. 1 begins with an end user selecting one or more database servers as accessed by the inventive interface. These servers would include databases with forms of data to be used in a logical relation to the operation of some entity or activity as opposed to random data which has no relational function to the operation.

FIG. 1 shows the next step wherein the user selects a database from which to begin creating a structure that will be saved as a query. The next step in FIG. 1 illustrates that a database table may be selected using a combo box, or drop down set of options which combines much of the functionality of a list box and an edit control.

The user then selects FOR OUTPUT any database columns the user wishes to select from the database table produced via the previous step. Also re FIG. 1, a list is generated of said selected columns. Further to FIG. 1 the user reflects the JOIN column or columns from the table.

FIG. 1 illustrates the next step wherein the user reflects a table from the first list and then reflects a column or columns from a second table to JOIN to. The data is then defined as a structure in which the data is JOINED, again utilizing a combo box drop down of options.

Finally, re FIG. 1, the data is saved as a query and the user may specify a location, file name, file extension, file format, etc.

1) A method of database integration using a Graphical User Interface GUI and transactional SQL to effect a set of data comprising the steps:
a. end user selects one or more database servers presented via interface;
b. user selects a database from one or more servers;
c. the database server presents a table or tables and the interface provides a combo box for drop down options as a list box and an edit control;
d. user selects any of the table columns to serve as output;
e. interface displays a second list of tables;
f. interface displays the JOIN clause (combining fields from two or more tables by using values common to each column from table);
g. interface reflects table from second list;
h. interface reflects second column from table to JOIN and user selects;
i. user defines structure in which the set of data is JOINED via selections from the combo box;
j. user saves structure as query to user's computer.

2) A method of database integration using a Graphical User Interface GUI and translational SQL to effect a set of data as in claim 1 wherein the tables may be acquired from multiple databases, and wherein the number of tables and columns selected for JOINS is inhibited only by the processing ability of a computer or server used to to output the set of data.
